(19) United States
(12) Patent Application Publication
(10) Pub. No.: US 2020/0020479 A1
(43) Pub. Date: Jan. 16, 2020

(54) MODULE COMPONENT AND POWER SUPPLY CIRCUIT

(71) Applicant: Murata Manufacturing Co., Ltd., Nagaokakyo-shi (JP)

(72) Inventor: Takanori TSUCHIYA, Nagaokakyo-shi (JP)

(21) Appl. No.: 16/581,862

(22) Filed: Sep. 25, 2019

Related U.S. Application Data
(63) Continuation of application No. PCT/JP2018/021237, filed on Jun. 1, 2018.

(30) Foreign Application Priority Data
Jul. 3, 2017 (JP) 2017-130099

(51) Int. Cl. H01F 27/38; H01F 27/06; H01F 27/36; H01F 27/02; H01F 27/40

(52) U.S. Cl. CPC H01F 27/38; H01F 27/06; H01F 27/40; H01F 27/365; H01F 27/022; H01F 27/362

(57) ABSTRACT

A mount device and a substrate are provided. The mount device includes a first inductor conductor. The substrate includes a first main surface and contains a second inductor conductor. The mount device is mounted on the first main surface. The first inductor conductor and the second inductor conductor are electrically connected with each other. The mount device and the substrate are disposed at positions at which a first magnetic flux generated from the first inductor conductor and a second magnetic flux generated from the second inductor conductor attenuate each other.

### CROSS REFERENCE TO RELATED APPLICATIONS

This application claims the benefit of priority to Japanese Patent Application No. 2017-130099 filed on Jul. 3, 2017 and is a Continuation Application of PCT Application No. PCT/JP2018/021237 filed on Jun. 1, 2018. The entire contents of each application are hereby incorporated herein by reference.

### BACKGROUND OF THE PRESENT INVENTION

### 1. Field of the Present Invention

The present invention relates to a module component and a power supply circuit using the module component.

### 2. Description of the Related Art

Concerning a module component of the related art, the configuration in which an inductor device is mounted on a substrate, as disclosed in Japanese Unexamined Patent Application Publication No. 2016-70848, and the configuration in which an inductor conductor is formed within a substrate, as disclosed in Japanese Unexamined Patent Application Publication No. 2012-65408, are known.

To increase the inductor value, typically, a large inductor device is required in the structure disclosed in Japanese Unexamined Patent Application Publication No. 2016-70848, and, it is necessary to increase the number of turns of the inductor conductor built in the substrate in the structure disclosed in Japanese Unexamined Patent Application Publication No. 2012-65408.

In the case of the structure disclosed in Japanese Unexamined Patent Application Publication No. 2016-70848, however, increasing the size of the inductor device enlarges the overall module component. In the case of the structure disclosed in Japanese Unexamined Patent Application Publication No. 2012-65408, increasing the number of turns of the inductor conductor makes the overall module component thick.

Additionally, increasing the inductor value intensifies noise from an inductor, such as an inductor device and an inductor conductor.

### SUMMARY OF THE INVENTION

Preferred embodiments of the present invention provide an increase to the inductor value without enlarging a module component and to reduce noise from an inductor conductor.

A module component according to a preferred embodiment of the present invention includes a mount device and a substrate. The mount device includes a first inductor conductor. The substrate includes a first main surface and includes a second inductor conductor therein. The mount device is mounted on the first main surface. The first and second inductor conductors are electrically connected with each other. The mount device and the substrate are disposed at positions at which a first magnetic flux generated from the first inductor conductor and a second magnetic flux generated from the second inductor conductor attenuate each other. In this configuration, the first inductor conductor and the second inductor conductors are electrically connected with each other, thus increasing the inductor value. The mount device and the substrate are disposed at positions at which the first magnetic flux and the second magnetic flux attenuate each other, thus reducing leakage flux from each of the first magnetic flux and the second magnetic flux.

In a module component according to a preferred embodiment of the present invention, each of the first inductor conductor and the second inductor conductor may preferably be provided in a shape in which they are wound on a winding axis. The winding axis of the first inductor conductor and that of the second inductor conductor may preferably be perpendicular or substantially perpendicular to the first main surface. This configuration may be used in a mount device including a winding axis positioned in parallel with the thickness direction of the module component.

In a module component according to a preferred embodiment of the present invention, when the module component is viewed from a side of the first main surface, an opening of the first inductor conductor and that of the second inductor conductor may preferably at least partially overlap each other. With this configuration, the first magnetic flux generated from the first inductor conductor and the second magnetic flux generated from the second inductor conductor can attenuate each other efficiently.

In a module component according to a preferred embodiment of the present invention, each of the first inductor conductor and the second inductor conductor may preferably be provided in a shape in which it is wound on a winding axis. The winding axis of the first inductor conductor may preferably be parallel or substantially parallel with the first main surface, and the winding axis of the second inductor conductor may preferably be perpendicular or substantially perpendicular to the first main surface. This configuration can be used in a mount device having a winding axis positioned perpendicularly or substantially perpendicular to the thickness direction of the module component.

In a module component according to a preferred embodiment of the present invention, when the module component is viewed from a side of the first main surface, an opening of the second inductor conductor may preferably at least partially overlap an opening at an end portion of the first inductor conductor. With this configuration, the first magnetic flux generated from the first inductor conductor and the second magnetic flux generated from the second inductor conductor can attenuate each other efficiently.

A module component according to a preferred embodiment of the present invention may preferably further include a third inductor conductor disposed on a side of a top surface of the mount device. The third inductor conductor may preferably be disposed at a position at which the first magnetic flux generated from the first inductor conductor and a third magnetic flux generated from the third inductor conductor attenuate each other. With this configuration, the first magnetic flux generated from the first inductor conductor toward the top surface of the mount device and the third magnetic flux generated from the third inductor conductor attenuate each other. In a module component according to a preferred embodiment of the present invention, the third inductor conductor may preferably be disposed on a top surface of a resin cover layer. This configuration makes it easy to provide the third inductor conductor at a desired position.

A module component according to a preferred embodiment of the present invention may further include a resin cover layer that covers the mount device and a shield layer that covers the resin cover layer and blocks noise. With this configuration, the mount device is protected by the resin cover layer to improve the reliability. The mount device is also covered with the shield layer to reduce noise from the mount device.

In a module component according to a preferred embodiment of the present invention, the substrate may preferably have a multilayer structure including a magnetic layer and a non-magnetic layer. The non-magnetic layer may preferably be disposed between the mount device and the magnetic layer. With this configuration, the non-magnetic layer reduces magnetic saturation of the inductor conductors, thus improving the DC bias characteristics.

In a module component according to a preferred embodiment of the present invention, the substrate may preferably include a second main surface which opposes the first main surface. A ground pattern may preferably be disposed between the second main surface and the second inductor conductor. This configuration makes it possible to reduce noise leaking from the second main surface of the substrate.

In a module component according to a preferred embodiment of the present invention, the first inductor conductor and the second inductor conductor may preferably be connected in series with each other. This configuration makes it possible to increase the inductor value of the module component as a whole.

A module component according to a preferred embodiment of the present invention may preferably include a plurality of pairs, each pair including the first inductor conductor and the second inductor conductor. The plurality of pairs of the first inductor conductor and the second inductor conductor may preferably be connected in series with each other. This configuration makes it possible to further increase the inductor value of the module component as a whole.

A module component according to a preferred embodiment of the present invention may preferably include a plurality of pairs, each pair including the inductor conductor and the second inductor conductor. The plurality of pairs of the inductor conductor and the second inductor conductor may preferably be individually arranged. With this configuration, a single module component can be used as multiple circuits which externally connect to other devices, or the plurality of pairs of inductors can be connected in series with each other to increase the inductance.

In a module component according to a preferred embodiment of the present invention, a first inductor value of the first inductor conductor may preferably be about ten times as high as a second inductor value of the second inductor conductor. With this configuration, while the first inductor conductor having excellent characteristics is used as a major inductor, the second inductor conductor can be used as an auxiliary inductor to reduce leakage flux of the first inductor conductor, thus improving the characteristics of the module component.

A power supply circuit according to a preferred embodiment of the present invention includes the module component. The first inductor conductor and the second inductor conductor are used as a choke coil. With this configuration, the inductor value is increased, thus implementing a power supply circuit including a choke coil exhibiting excellent characteristics, such as reducing of leakage flux.

According to preferred embodiments of the present invention, it is possible to provide a structure that increases the inductor value without enlarging a module component and that reduces noise from an inductor conductor.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is a schematic side view of a module component according to a first preferred embodiment of the present invention, and FIG. 1B is an enlarged schematic side view of a portion of FIG. 1A.

FIG. 2 is a perspective view illustrating the positional relationship of an inductor conductor 200 to a built-in inductor conductor 300 in the module component 10 according to the first preferred embodiment of the present invention.

FIG. 3 is a plan view illustrating the positional relationship of the inductor conductor 200 to the built-in inductor conductor 300 in the module component 10 according to the first preferred embodiment of the present invention.

FIG. 4 is an equivalent circuit diagram of a power supply circuit 1 including the module component 10 according to the first preferred embodiment of the present invention.

FIG. 5A is a schematic side view of a module component 10A according to a second preferred embodiment of the present invention, and FIG. 5B is an enlarged schematic side view of a portion of FIG. 5A.

FIG. 6 is a perspective view illustrating the positional relationship of an inductor conductor 200A to built-in inductor conductors 301A and 302A in the module component 10A according to the second preferred embodiment of the present invention.

FIG. 7 is a plan view illustrating the positional relationship of the inductor conductor 200A to the built-in inductor conductors 301A and 302A in the module component 10A according to the second preferred embodiment of the present invention.

FIG. 8 is an equivalent circuit diagram of a power supply circuit 1A including the module component 10A according to the second preferred embodiment of the present invention.

FIG. 9A is a schematic side view of a module component 10B according to a third preferred embodiment of the present invention, and FIG. 9B is an enlarged schematic side view of a portion of FIG. 9A.

FIG. 10 is a perspective view illustrating the positional relationship of an inductor conductor 200 to a built-in inductor conductor 300 and a third inductor conductor 800 in the module component 10B according to the third preferred embodiment of the present invention.

FIG. 11 is a plan view illustrating the positional relationship of the inductor conductor 200 to the built-in inductor conductor 300 and the third inductor conductor 800 in the module component 10B according to the third preferred embodiment of the present invention.

FIG. 12A is a schematic side view of a module component 10C according to a fourth preferred embodiment of the present invention, and FIG. 12B is an enlarged schematic side view of a portion of FIG. 12A.

### DETAILED DESCRIPTION OF THE PREFERRED EMBODIMENTS

Preferred embodiments of the present invention will be described in detail below with reference to the accompanying drawings.

### First Preferred Embodiment

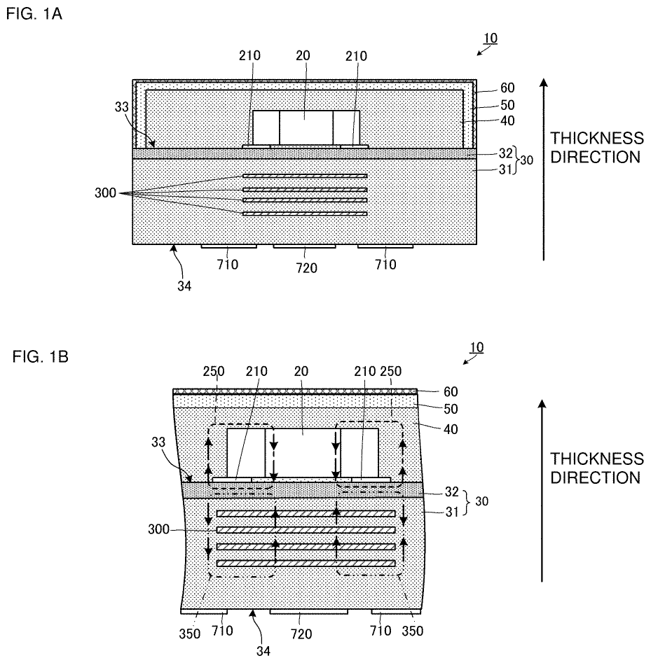

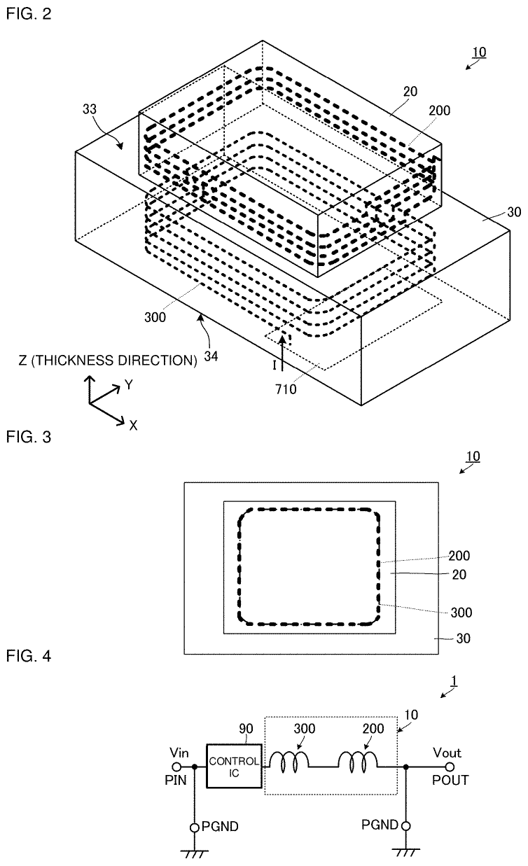

A module component according to a first preferred embodiment of the present invention will be described below with reference to the drawings. FIG. 1A is a schematic side view of a module component 10 according to the first preferred embodiment of the present invention. FIG. 1B is an enlarged schematic side view of a portion of FIG. 1A. FIG. 2 is a perspective view illustrating the positional relationship of an inductor conductor 200 to a built-in inductor conductor 300 in the module component 10 according to the first preferred embodiment of the present invention. FIG. 3 is a plan view illustrating the positional relationship of the inductor conductor 200 to the built-in inductor conductor 300 in the module component 10 according to the first preferred embodiment of the present invention. FIG. 4 is an equivalent circuit diagram of a power supply circuit 1 including the module component 10 according to the first preferred embodiment of the present invention. For easy representation, in the above-described drawings, some of the reference numerals are not shown, and the dimensional relationships between the elements are suitably changed.

As shown in FIG. 1A, the module component 10 preferably includes a surface mount electronic device 20, a substrate 30, the built-in inductor conductor 300, a sealing resin 40, a magnetic shield layer 50, and a metal shield layer 60. The surface mount electronic device 20 is preferably a mount device in preferred embodiments of the present invention.

The substrate 30 preferably has a rectangular or substantially rectangular shape in a plan view, that is, the substrate 30 preferably has a rectangular or substantially rectangular prism shape. In other words, the substrate 30 preferably includes first and second main surfaces 33 and 34 which oppose each other and side surfaces which interconnect the first and second main surfaces 33 and 34.

The substrate 30 is preferably a multilayer structure defined by a magnetic layer 31 and a non-magnetic layer 32 stacked on each other in the thickness direction in this order. The second main surface 34 of the substrate 30 is positioned on the side of the magnetic layer 31, while the first main surface 33 thereof is positioned on the side of the non-magnetic layer 32.

Land conductors 210 used in mounting a device are preferably defined on the first main surface 33 of the substrate 30. The surface mount electronic device 20 is mounted on the land conductors 210.

On the second main surface 34 of the substrate 30, external connecting terminal electrodes 710 and a ground electrode 720 are preferably provided. The terminal electrodes 710 and the ground electrode 720 are connected as a predetermined circuit pattern to the built-in inductor conductor 300 and the land conductors 210 via an electrode pattern (not shown) provided in the substrate 30.

The sealing resin 40 is preferably provided on the first main surface 33 of the substrate 30. The sealing resin 40 covers the surface mount electronic device 20.

The magnetic shield layer 50 is provided on the first main surface 33 of the substrate 30. The magnetic shield layer 50 covers the sealing resin 40.

The metal shield layer 60 is provided on the first main surface 33 of the substrate 30. The metal shield layer 60 covers the magnetic shield layer 50.

The metal shield layer 60 blocks high-frequency noise radiated from the surface mount electronic device 20 to the exterior. The magnetic shield layer 50 can block low-frequency noise.

The surface mount electronic device 20 is preferably an inductor including the inductor conductor 200 and having an inductor value L1. The inductor conductor 200 is a first inductor conductor. For example, the inductor conductor 200 is preferably provided in a shape in which it is wound on a winding axis positioned in the thickness direction.

The magnetic layer 31 preferably includes the built-in inductor conductor 300 and has an inductor value L2. The built-in inductor conductor 300 is a second inductor conductor and defines an inductor. As in the inductor conductor 200, for example, the built-in inductor conductor 300 is preferably formed in a shape in which it is wound on a winding axis positioned in the thickness direction.

The inductor value L1 of the inductor conductor 200 is preferably, for example, about ten times as high as the inductor value L2 of the built-in inductor conductor 300.

The inductor conductor 200 and the built-in inductor conductor 300 are electrically connected in series with each other via an inner electrode, which is not shown. Accordingly, the overall inductor value L of the module component 10 is expressed by L1+L2.

The inductor conductor 200 and the built-in inductor conductor 300 electrically connected in series with each other are wound on the winding axes such that magnetic flux generated from the inductor conductor 200 and that from the built-in inductor conductor 300 flow in the opposite directions at a certain time point when an AC voltage is applied.

More specifically, as shown in FIG. 2, for example, the inductor conductor 200 (surface mount electronic device 20) has a spiral shape defined by connecting plural linear conductor patterns wound in a plane parallel or substantially parallel with the X axis and the Y axis (plane parallel or substantially parallel with the first main surface 33) on a winding axis positioned in the Z-axis direction. The built-in inductor conductor 300 within the substrate 30 also preferably has a spiral shape defined by connecting plural linear conductor patterns wound in a plane parallel or substantially parallel with the X axis and the Y axis on a winding axis positioned in the Z-axis direction. However, the built-in inductor conductor 300 is wound in the direction opposite that of the inductor conductor 200. The Z-axis direction is the thickness direction in FIGS. 1A and 1B.

In this configuration, a current I is caused to flow from the terminal electrode 710 to the inductor conductor 200 and the built-in inductor conductor 300. In this case, as shown in FIG. 1B, a first magnetic flux 250 is generated from the inductor conductor 200, while a second magnetic flux 350 is generated from the built-in inductor conductor 300.

More specifically, in a plan view, the first magnetic flux 250 is generated inside the opening of the inductor conductor 200 in the thickness direction, while the second magnetic flux 350 is generated inside the opening of the built-in inductor conductor 300 in the thickness direction. The second magnetic flux 350 is generated in the direction opposite that of the first magnetic flux 250 in the thickness direction. The first magnetic flux 250 and the second magnetic flux 350 thus attenuate each other.

In this manner, the inductor conductor 200 (surface mount electronic device 20) and the built-in inductor conductor 300 are disposed at positions at which the first magnetic flux 250 and the second magnetic flux 350 attenuate each other in the thickness direction. This can decrease the first magnetic flux 250 and the second magnetic flux 350, thus also reducing the leakage flux of the module component 10 as a whole.

As to the more specific positional relationship between the inductor conductor 200 and the built-in inductor conductor 300, the opening of the inductor conductor 200 and that of the built-in inductor conductor 300 overlap each other, as shown in FIG. 3. That is, the inductor conductor 200 and the built-in inductor conductor 300 overlap each other on or substantially on the entire periphery in a plan view.

This can increase the range by which the first magnetic flux 250 and the second magnetic flux 350 overlap each other in the opposite directions, thus improving the effect of attenuating the magnetic flux. It is not necessary that the opening of the inductor conductor 200 and that of the built-in inductor conductor 300 perfectly overlap each other. If the opening of the inductor conductor 200 and that of the built-in inductor conductor 300 at least partially overlap each other, the effect of attenuating the magnetic flux is achieved.

The module component 10 is applicable to a choke coil in the power supply circuit 1, as shown in FIG. 4. As illustrated in the equivalent circuit diagram of FIG. 4, the power supply circuit 1 preferably includes a control Integrated Circuit (IC) 90, the inductor conductor 200, the built-in inductor conductor 300, a voltage input terminal Vin, and a voltage output terminal Vout. The inductor conductor 200 and the built-in inductor conductor 300 are preferably a portion of the module component 10. The inductor conductor 200 and the built-in inductor conductor 300 are connected in series with each other. As discussed above, the overall inductor value L of the module component 10 is expressed by L1+L2. That is, the inductor value L is equal to the value obtained by adding the inductor value of the built-in inductor conductor 300 to that of the inductor conductor 200, thus increasing the inductor value.

Although the overall inductor value L of the module component 10 is increased, the first magnetic flux 250 and the second magnetic flux 350 attenuate each other and the leakage flux thereof is decreased. The performance of the module component 10 is thus improved.

That is, the inductor value of the choke coil can be increased without enlarging the power supply circuit 1, and the leakage flux to the exterior is also reduced.

Additionally, the non-magnetic layer 32 of the substrate 30 preferably provided between the inductor conductor 200 and the built-in inductor conductor 300 connected with each other can reduce magnetic saturation therebetween. This can improve the DC bias characteristics.

The entirety of the above-described power supply circuit 1 may be packaged as a component, as in the module component 10.

It is preferable that the winding axis of the inductor conductor 200 and that of the built-in inductor conductor 300 are located at the same or substantially the same position and in the same or substantially the same orientation. It is also preferable that the inner diameter and the outer diameter of the inductor conductor 200 are equal or substantially equal to those of the built-in inductor conductor 300. These arrangements implement the module component 10 exhibiting even better characteristics.

### Second Preferred Embodiment

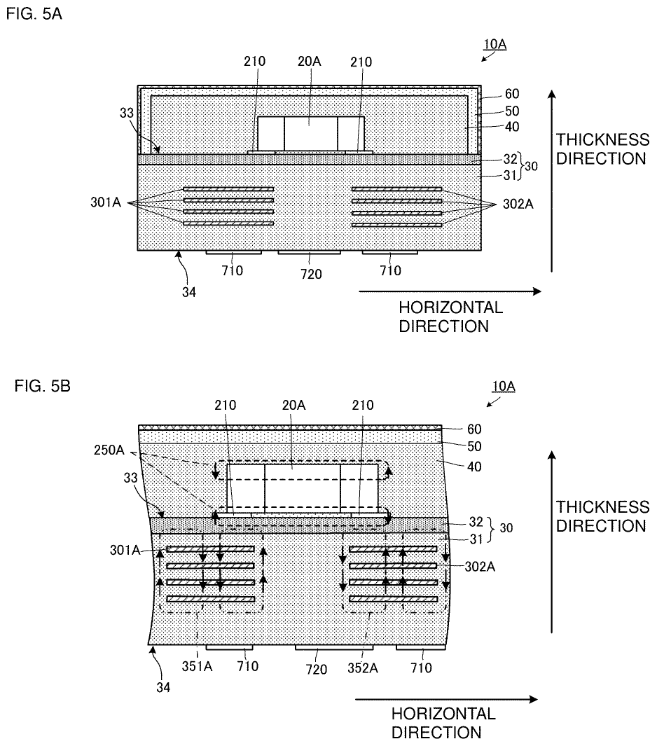

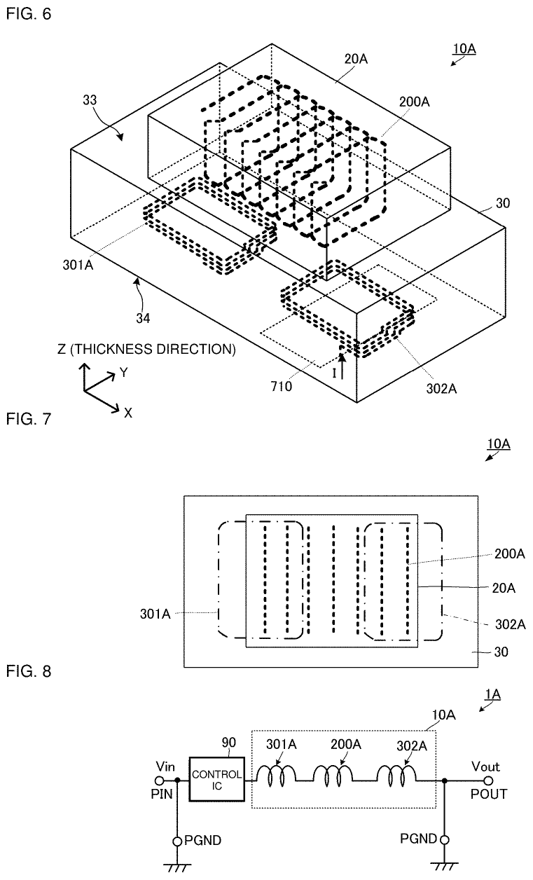

A module component according to a second preferred embodiment of the present invention will be described below with reference to the drawings. FIG. 5A is a schematic side view of a module component 10A according to the second preferred embodiment of the present invention. FIG. 5B is an enlarged schematic side view of a portion of FIG. 5A. FIG. 6 is a perspective view illustrating the positional relationship of an inductor conductor 200A to built-in inductor conductors 301A and 302A in the module component 10A according to the second preferred embodiment of the present invention. FIG. 7 is a plan view illustrating the positional relationship of the inductor conductor 200A to the built-in inductor conductors 301A and 302A in the module component 10A according to the second preferred embodiment of the present invention. FIG. 8 is an equivalent circuit diagram of a power supply circuit 1A including the module component 10A according to the second preferred embodiment of the present invention. For easy representation, in the above-described drawings, some of the reference numerals are not shown, and the dimensional relationships between the elements are suitably changed.

As shown in FIGS. 5A, 5B, and in FIGS. 6, 7, and 8, the module component 10A of the second preferred embodiment is preferably different from the module component 10 of the first preferred embodiment in that the shape of the inductor conductor 200A of a surface mount electronic device 20A is different and in that the built-in inductor conductors 301A and 302A are provided. The configurations of the other elements of the module component 10A are the same as or similar to those of the module component 10, and an explanation thereof will thus be omitted. The surface mount electronic device 20A is a mount device in the present preferred embodiment.

As shown in FIG. 5A, the module component 10A includes the surface mount electronic device 20A, a substrate 30, the built-in inductor conductors 301A and 302A, a sealing resin 40, a magnetic shield layer 50, and a metal shield layer 60.

The surface mount electronic device 20A is an inductor including the inductor conductor 200A and having an inductor value L1. For example, the inductor conductor 200A preferably has a spiral shape in which it is wound on a winding axis positioned in the horizontal direction perpendicular or substantially perpendicular to the thickness direction.

The magnetic layer 31 preferably includes the built-in inductor conductors 301A and 302A. The inductor value of the built-in inductor conductor 301A is L21, and that of the built-in inductor conductor 302A is L22.

The built-in inductor conductors 301A and 302A are disposed at positions corresponding to the openings of the inductor conductor 200A when viewed in plan. The built-in inductor conductor 301A is preferably provided, for example, in a shape in which it is wound on a winding axis positioned in the thickness direction. The built-in inductor conductor 302A is preferably provided, for example, in a shape in which it is wound on a winding axis positioned in the thickness direction. The built-in inductor conductors 301A and 302A each define an inductor.

The inductor conductor 200A is electrically connected in series with the built-in inductor conductors 301A and 302A via an inner electrode, which is not shown. Accordingly, the overall inductor value L of the module component 10A is expressed by L1+(L21+L22).

An AC voltage is applied to the inductor conductor 200A and the built-in inductor conductors 301A and 302A. In this case, the magnetic flux generated from the built-in inductor conductor 301A and that from the built-in inductor conductor 302A at a certain time point flow in the opposite directions. The magnetic flux generated from the inductor conductor 200A and that from the built-in inductor conductor 301A also flow in the opposite directions, and the magnetic flux generated from the inductor conductor 200A and that from the built-in inductor conductor 302A also flow in the opposite directions.

The positional relationships of the inductor conductor 200A to the built-in inductor conductors 301A and 302A in the module component 10A are shown in the perspective view of FIG. 6. The Z-axis direction is the thickness direction in FIGS. 5A and 5B. For example, the inductor conductor 200A (surface mount electronic device 20A) preferably has a spiral shape defined by connecting plural linear conductor patterns wound in a plane parallel or substantially parallel with the Y axis and the Z axis (plane perpendicular or substantially perpendicular with the first main surface 33) on a winding axis positioned in the X-axis direction. The built-in inductor conductors 301A and 302A within the substrate 30 each preferably have a spiral shape defined by connecting plural linear conductor patterns wound in a plane parallel or substantially parallel with the X axis and the Y axis on a winding axis positioned in the Z-axis direction.

The more specific positional relationships between the inductor conductor 200A and the built-in inductor conductors 301A and 302A will be explained. In a plan view, the opening at one end portion of the inductor conductor 200A and the opening of the built-in inductor conductor 301A overlap each other, while the opening at the other end portion of the inductor conductor 200A and the opening of the built-in inductor conductor 302A overlap each other. With this arrangement, a first magnetic flux 250A overlaps each of a second magnetic flux 351A and a second magnetic flux 352A by a certain range in the opposite directions.

As shown in FIG. 5B, a current I is caused to flow from a terminal electrode 710 to the inductor conductor 200A and the built-in inductor conductors 301A and 302A. The first magnetic flux 250A is generated from the inductor conductor 200A, the second magnetic flux 351A is generated from the built-in inductor conductor 301A, and the second magnetic flux 352A is generated from the built-in inductor conductor 302A.

At one end portion of the inductor conductor 200A from which the first magnetic flux 250A is generated in the thickness direction, the second magnetic flux 351A is generated in the thickness direction and in the direction opposite that of the first magnetic flux 250A. The first magnetic flux 250A and the second magnetic flux 351A thus attenuate each other.

Similarly, at another end portion of the inductor conductor 200A from which the first magnetic flux 250A is generated in the thickness direction, the second magnetic flux 352A is generated in the thickness direction and in the direction opposite that of the first magnetic flux 250A. The first magnetic flux 250A and the second magnetic flux 352A thus attenuate each other.

As a result of the first magnetic flux 250A, the second magnetic flux 351A, and the second magnetic flux 352A attenuating each other, the leakage flux is decreased, thus reducing the leakage flux of the module component 10A as a whole.

The module component 10A is applicable to a choke coil in the power supply circuit 1A, as shown in FIG. 8. As illustrated in the equivalent circuit diagram of FIG. 8, the power supply circuit 1A preferably includes a control IC 90, the inductor conductor 200A, the built-in inductor conductors 301A and 302A, a voltage input terminal Vin, and a voltage output terminal Vout. The inductor conductor 200A and the built-in inductor conductors 301A and 302A are portions of the module component 10A. The inductor conductor 200A and the built-in inductor conductors 301A and 302A are preferably electrically connected in series with each other. As discussed above, the overall inductor value L of the module component 10A is expressed by L1+(L21+L22). That is, the inductor value L of the module component 10A is equal to the value obtained by adding the inductor values of the built-in inductor conductors 301A and 302A to the inductor value of the inductor conductor 200A, thus increasing the inductor value.

Although the overall inductor value L of the module component 10A is increased, the leakage flux of the module component 10A is decreased. That is, the performance of the module component 10A is improved.

That is, the inductor value of the choke coil can be increased without enlarging the power supply circuit 1A, and the leakage flux to the exterior is also reduced.

Additionally, the non-magnetic layer 32 of the substrate 30 preferably provided between the inductor conductor 200A and the built-in inductor conductors 301A and 302A connected with each other can reduce magnetic saturation therebetween. This can improve the DC bias characteristics.

The entirety of the above-described power supply circuit 1A may be packaged as a component, as in the module component 10A.

### Third Preferred Embodiment

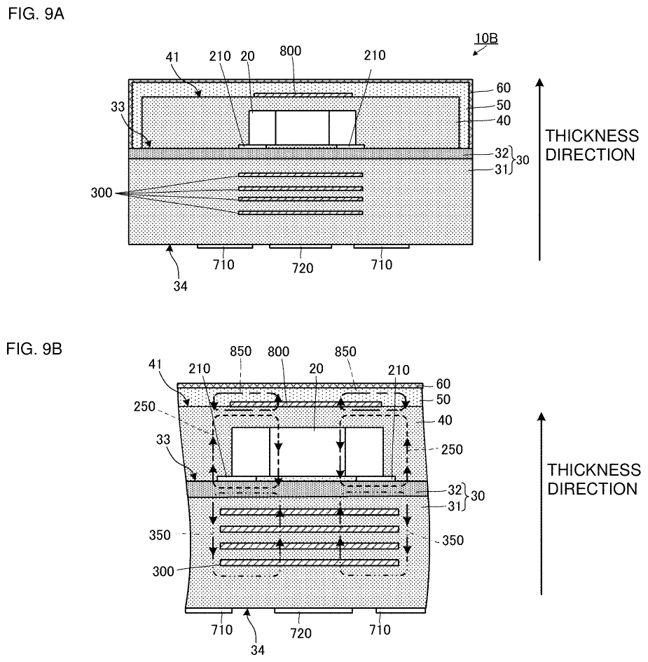

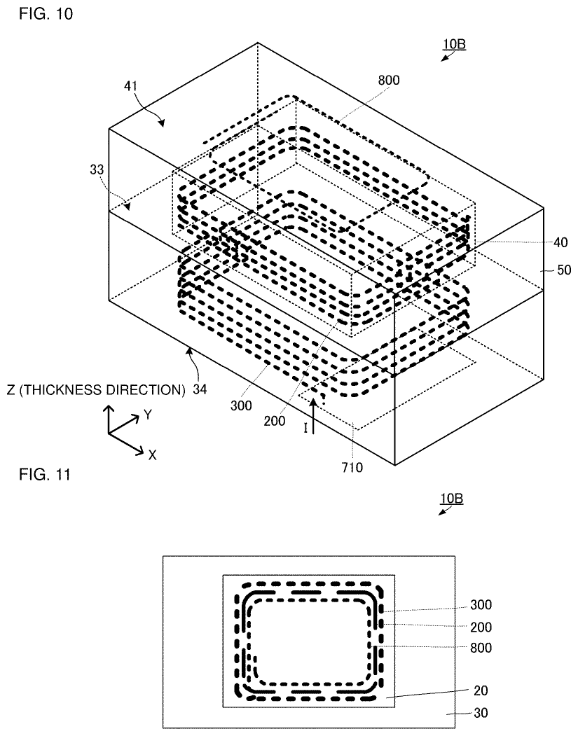

A module component according to a third preferred embodiment of the present invention will be described below with reference to the drawings. FIG. 9A is a schematic side view of a module component 10B according to the third preferred embodiment of the present invention. FIG. 9B is an enlarged schematic side view of a portion of FIG. 9A. FIG. 10 is a perspective view illustrating the positional relationship of an inductor conductor 200 to a built-in inductor conductor 300 and a third inductor conductor 800 in the module component 10B according to the third preferred embodiment of the present invention. FIG. 11 is a plan view illustrating the positional relationship of the inductor conductor 200 to the built-in inductor conductor 300 and the third inductor conductor 800 in the module component 10B according to the third preferred embodiment of the present invention. For easy representation, in the above-described drawings, some of the reference numerals are not shown, and the dimensional relationships between the elements are suitably changed.

As shown in FIGS. 9A, 9B, and FIGS. 10 and 11, the module component 10B of the third preferred embodiment is preferably different from the module component 10 of the first preferred embodiment in that the third inductor conductor 800 is provided. The configurations of the other elements of the module component 10B are the same as or similar to those of the module component 10, and an explanation thereof will thus be omitted.

As shown in FIG. 9A, the module component 10B preferably includes a surface mount electronic device 20, a substrate 30, the built-in inductor conductor 300, a sealing resin 40, a magnetic shield layer 50, a metal shield layer 60, and the third inductor conductor 800.

The sealing resin 40 includes a top surface 41 which does not abut on the first main surface 33 of the substrate 30. The third inductor conductor 800 is provided on the top surface 41. The third inductor conductor 800 is preferably provided in a spiral shape defined by a linear conductor pattern wound in a plan view of the top surface 41, that is, in a plane parallel or substantially parallel with the X-axis direction and the Y-axis direction. The third inductor conductor 800 defines an inductor.

As shown in FIG. 9B, a current I is caused to flow from a terminal electrode 710 to the inductor conductor 200 and the built-in inductor conductor 300. A first magnetic flux 250 is generated from the inductor conductor 200, while a second magnetic flux 350 is generated from the built-in inductor conductor 300.

As shown in FIG. 10, for example, the inductor conductor 200 (surface mount electronic device 20) preferably has a spiral shape defined by connecting plural linear conductor patterns wound in a plane parallel or substantially parallel with the X-axis direction and the Y-axis direction on a winding axis positioned in the Z-axis direction.

The built-in inductor conductor 300 within the substrate 30 preferably has a spiral shape defined by connecting plural linear conductor patterns wound in a plane parallel or substantially parallel with the X-axis direction and the Y-axis direction on a winding axis positioned in the Z-axis direction.

As in the module component 10 of the first preferred embodiment, the inductor conductor 200 (surface mount electronic device 20) and the built-in inductor conductor 300 are disposed at positions at which the first magnetic flux 250 and the second magnetic flux 350 attenuate each other in the thickness direction.

As discussed above, the inductor conductor 200 and the built-in inductor conductor 300 are preferably electrically connected in series with each other via an inner electrode, which is not shown. The third inductor conductor 800 is preferably electrically connected in series with the inductor conductor 200 and the built-in inductor conductor 300 and generates a third magnetic flux 850.

In a plan view, the third magnetic flux 850 is generated inside the opening of the third inductor conductor 800 in the thickness direction, while the first magnetic flux 250 is generated inside the opening of the inductor conductor 200 in the thickness direction. The third magnetic flux 850 is generated in the direction opposite that of the first magnetic flux 250 in the thickness direction. The third magnetic flux 850 and the first magnetic flux 250 thus attenuate each other.

As to the more specific positional relationships among the inductor conductor 200, the built-in inductor conductor 300, and the third inductor conductor 800, the opening of the inductor conductor 200, that of the built-in inductor conductor 300, and that of the third inductor conductor 800 overlap each other, as shown in FIG. 11. This configuration can increase the range by which the first magnetic flux 250 and the second magnetic flux 350 overlap each other in the opposite directions and the range by which the first magnetic flux 250 and the third magnetic flux 850 overlap each other in the opposite directions, thus improving the effect of attenuating the magnetic flux.

It is not necessary that the opening of the inductor conductor 200 and that of the built-in inductor conductor 300 perfectly overlap each other. Similarly, it is not necessary that the opening of the inductor conductor 200 and that of the third inductor conductor 800 perfectly overlap each other. It is sufficient if the opening of the inductor conductor 200 at least partially overlaps each of the opening of the built-in inductor conductor 300 and that of the third inductor conductor 800.

With this configuration, the inductor value L becomes equal to the value obtained by adding the inductor value of the built-in inductor conductor 300 to that of the inductor conductor 200, thus increasing the overall inductor value.

Although the overall inductor value L of the module component 10B is increased, the leakage flux of the module component 10B is decreased. The performance of the module component 10B is thus improved.

### Fourth Preferred Embodiment

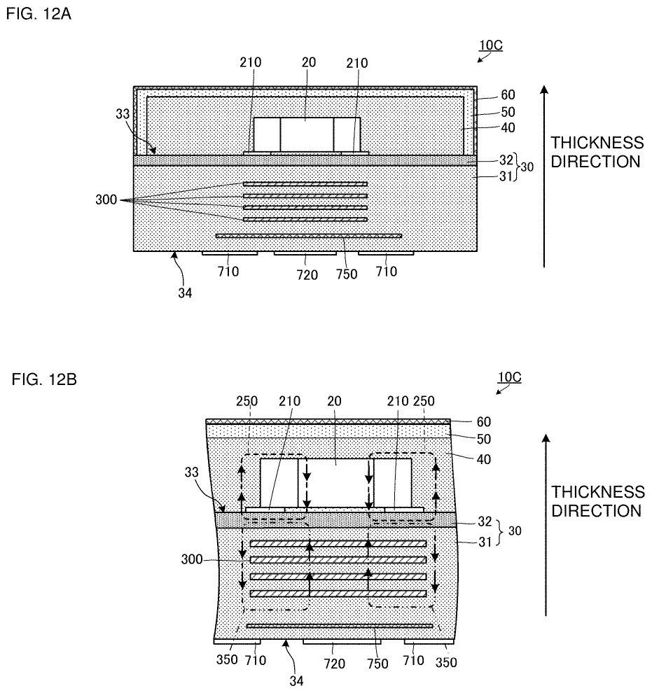

A module component according to a fourth preferred embodiment of the present invention will be described below with reference to the drawings. FIG. 12A is a schematic side view of a module component 10C according to the fourth preferred embodiment of the present invention. FIG. 12B is an enlarged schematic side view of a portion of FIG. 12A. For easy representation, in the above-described drawings, some of the reference numerals are not shown, and the dimensional relationships between the elements are suitably changed.

As shown in FIGS. 12A and 12B, the module component 10C of the fourth preferred embodiment is preferably different from the module component 10 of the first preferred embodiment in that an inner-layer ground conductor 750 is provided. The configurations of the other elements of the module component 10C are similar to those of the module component 10, and an explanation thereof will thus be omitted.

As shown in FIG. 12A, the module component 10C preferably includes a surface mount electronic device 20, a substrate 30, a built-in inductor conductor 300, a sealing resin 40, a magnetic shield layer 50, a metal shield layer 60, and the inner-layer ground conductor 750.

The inner-layer ground conductor 750 is provided between the built-in inductor conductor 300 and a second main surface 34 of the substrate 30. The inner-layer ground conductor 750 is preferably electrically connected to a ground electrode 720 via an inner electrode (not shown). Depending on the circuit configuration, the inner-layer ground conductor 750 may be connected to the built-in inductor conductor 300 via an inner electrode (not shown).

In a plan view, the inner-layer ground conductor 750 overlaps the inductor conductor 200 and the built-in inductor conductor 300. With this configuration, the inner-layer ground conductor 750 can block noise radiated from the inductor conductor 200 and the built-in inductor conductor 300 to the second main surface 34 of the substrate 30.

Although the inductor conductor and the built-in inductor conductor are connected in series with each other in the above-described preferred embodiments, they may be connected in parallel with each other.

In the above-described preferred embodiments, a magnetic substrate is used as the substrate. However, a dielectric substrate may be used.

The non-magnetic layer is preferably provided on the side of the first main surface in the above-described preferred embodiments. However, the non-magnetic layer may also be provided on the side of the second main surface, as well as on the first main surface. In this case, a warpage of a module component when it is fired can be prevented.

In the above-described preferred embodiments, the module component preferably includes one mount device (mount inductor) and the associated built-in inductor conductor. However, the module component may include plural mount inductors and plural built-in inductor conductors associated with each other. In this case, a mount inductor and a built-in inductor conductor of each pair are disposed so that magnetic flux generated from the mount inductor and that from the built-in inductor conductor can attenuate each other.

That is, the plural inductors defined by conductors may be arranged and be packaged as a component. In this case, the plural pairs of inductors may be connected in series with each other between a pair of terminal electrodes. Alternatively, the plural pairs of inductors may be separately arranged between a pair of terminal electrodes.

If the plural pairs of inductors are electrically connected in series with each other, the overall inductor value of the module component can further be increased. If the plural pairs of inductors are separately arranged, a single module component can be used as multiple circuits which externally connect to other devices, or the plural pairs of inductors can be connected in series with each other to increase the inductance.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A module component comprising:
a mount device including a first inductor conductor; and
a substrate including a first main surface and including a second inductor conductor therein; wherein
the mount device is mounted on the first main surface,
the first inductor conductor and the second inductor conductor are electrically connected with each other; and
the mount device and the substrate are disposed at positions at which a first magnetic flux generated from the first inductor conductor and a second magnetic flux generated from the second inductor conductor attenuate each other.

2. The module component according to claim 1, wherein
each of the first inductor conductor and the second inductor conductor is provided in a shape in which it is wound on a winding axis; and
the winding axis of the first inductor conductor and the winding axis of the second inductor conductor are perpendicular or substantially perpendicular to the first main surface.

3. The module component according to claim 1, wherein, when the module component is viewed in plan from the first main surface, an opening of the first inductor conductor and an opening of the second inductor conductor at least partially overlap each other.

4. The module component according to claim 1, wherein
each of the first inductor conductor and the second inductor conductor is provided in a shape in which it is wound on a winding axis;
the winding axis of the first inductor conductor is parallel or substantially parallel with the first main surface; and
the winding axis of the second inductor conductor is perpendicular or substantially perpendicular to the first main surface.

5. The module component according to claim 4, wherein, when the module component is viewed in plan from the first main surface, an opening of the second inductor conductor at least partially overlaps an opening at an end portion of the first inductor conductor.

6. The module component according to claim 1, further comprising:
a third inductor conductor on a side of a top surface of the mount device; wherein
the third inductor conductor is disposed at a position at which the first magnetic flux generated from the first inductor conductor and a third magnetic flux generated from the third inductor conductor attenuate each other.

7. The module component according to claim 6, wherein the third inductor conductor is on a top surface of a resin cover layer which covers the mount device.

8. The module component according to claim 1, further comprising:
a resin cover layer that covers the mount device; and
a shield layer that covers the resin cover layer and blocks noise.

9. The module component according to claim 1, wherein
the substrate has a multilayer structure including a magnetic layer and a non-magnetic layer; and
the non-magnetic layer is disposed between the mount device and the magnetic layer.

10. The module component according to claim 1, wherein
the substrate includes a second main surface which opposes the first main surface; and
a ground pattern is disposed between the second main surface and the second inductor conductor.

11. The module component according to claim 1, wherein the first inductor conductor and the second inductor conductor are electrically connected in series with each other.

12. The module component according to claim 11, wherein
a plurality of pairs, each of the plurality of pairs including the first inductor conductor and the second inductor conductor, are provided; and
the plurality of pairs of the first inductor conductors and the second inductor conductors are electrically connected in series with each other.

13. The module component according to claim 11, wherein
a plurality of pairs, each of the plurality of pairs including the first inductor conductor and the second inductor conductor, are provided; and
the plurality of pairs of the inductor conductors and the second inductor conductors are individually arranged.

14. The module component according to claim 1, wherein a first inductor value of the first inductor conductor is about ten times as high as a second inductor value of the second inductor conductor.

15. A power supply circuit comprising:
the module component according to claim 1; wherein
the first inductor conductor and the second inductor conductor define a choke coil.

16. The module component according to claim 1, further comprising:
a sealing resin provided on the first main surface of the substrate; and
a third inductor conductor on a side of a top surface of the mount device; wherein
each of the first inductor conductor, the second inductor conductor, and the third inductor conductor is provided in a shape in which it is wound on a winding axis;
the winding axis is perpendicular or substantially perpendicular to the first main surface.

17. The module component according to claim 11, further comprising a control integrated circuit electrically connected in series with the first inductor conductor and the second inductor conductor.

18. The module component according to claim 1, wherein an inner diameter and an outer diameter of the first inductor conductor are equal or substantially equal to an inner diameter and an outer diameter of the second inductor conductor.

19. The module component according to claim 4, wherein the second inductor conductor includes a plurality of second inductor conductors with winding axes perpendicular or substantially perpendicular to the first main surface.

20. The module component according to claim 19, wherein
an AC voltage is applied to the first inductor conductor and the plurality of second inductor conductors;
magnetic flux generated from the first inductor conductor and one of the plurality of second inductor conductors at a certain time point flow in opposite directions; and
magnetic flux generated from the one of the plurality of second inductor conductors and another one of the plurality of second inductor conductors at the certain time point flow in opposite directions.
